(19) United States
(12) Patent Application Publication
(10) Pub. No.: US 2021/0234644 A1
(43) Pub. Date: Jul. 29, 2021

(54) Communication System, Transmitter, Receiver and Communication Method

(71) Applicant: Futaba Corporation, Mobara-shi (JP)

(72) Inventors: Kazuhito WATANABE, Mobara-shi (JP); Takafumi KOMODA, Mobara-shi (JP)

(21) Appl. No.: 17/154,596

(22) Filed: Jan. 21, 2021

(30) Foreign Application Priority Data
Jan. 24, 2020 (JP) 2020-010304

(51) Int. Cl. H04L 1/18; H04L 12/741

(52) U.S. Cl. CPC H04L 1/1896; H04L 45/74

(57) ABSTRACT

A communication system that can improve throughput when performing data transmission with respect to a plurality of devices, is provided. The communication system includes a transmitter and a receiver. The transmitter includes a transmitting section which is capable of transmitting a composite packet containing a plurality of packets. The receiver includes a receiving section capable of receiving the composite packet, a data acquisition section configured to take out a packet addressed to own station from the received composite packet, and a transmission control section configured to provide instructions for transmitting a receipt acknowledgement signal after a waiting time period has elapsed after the reception of the composite packet, the waiting time period being provided according to a data location of the packet addressed to the own station in the composite packet.

### CROSS-REFERENCE TO RELATED APPLICATION

This application claims the priority benefit of Japanese Patent Application No. 2019-214594 filed Nov. 27, 2019, which is fully incorporated herein by reference.

### TECHNICAL FIELD

The present invention relates to the field of ad hoc networks for performing communication via a plurality of wireless apparatuses.

### BACKGROUND

In recent years, ad hoc networks have attracted attention. An ad hoc network is a network that includes a plurality of wireless apparatuses scattered within an area and that, when performing communication between wireless apparatuses that are located at a distance where direct communication cannot be performed, enables communication via another wireless apparatus. Such networks are referred to as multi-hop networks.

As a communication method in a multi-hop network, a method that performs data transmission to a plurality of devices by sequentially performing transmission of a control data frame and reception of an ACK packet with changing a transmission destination device, is known (for example, see FIG. 2 of Patent Document 1).

### PRIOR ART DOCUMENT

### Patent Document

Patent Document 1: JP 2016-092737 A

### SUMMARY OF THE INVENTION

However, in such method that alternately performs the transmission of the control data frame and the reception of the ACK packet with respect to the plurality of transmission destination devices, there is a reduction in the throughput. In view of the such problem, an object of the present invention is to improve throughput when transmitting data to a plurality of devices.

A communication system according to the present invention is a communication system including a transmitter and a receiver, wherein the transmitter includes a transmitting section which is capable of transmitting a composite packet containing a plurality of packets, and wherein the receiver includes a receiving section capable of receiving the composite packet, a data acquisition section configured to take out a packet addressed to own station from the received composite packet, and a transmission control section configured to provide instructions for transmitting a receipt acknowledgement signal after a waiting time period has elapsed after the reception of the composite packet, the waiting time period being provided according to a data location of the packet addressed to the own station in the composite packet. Consequently, at the transmitter, time to receive the receipt acknowledgement signals each for each of the plurality of packets is provided collectively after the transmission of the composite packet.

In the communication system described above, the composite packet may be provided with a region for each of the plurality of packets in which information indicative of a data location in the composite packet is stored. Thus, the information indicative of the data location of the packet addressed to the own station can be obtained from the composite packet at the receiver.

The transmission control section included in the communication system described above may provide instructions for transferring the composite packet instead of transmitting the receipt acknowledgement signal when all of the plurality of packets contained in the received composite packet are not addressed to the own station. When all of the plurality of packets contained in the received composite packet are not addressed to the own station, the transfer of the composite packet may be carried out. Further, the composite packet transferred by the receiver is also sent to the transmitter that has transmitted the composite packet to this receiver. Thus, the transmitter can know that the composite packet that it has transmitted was sent to the receiver.

The transmission control section included in the communication system described above may be configured to perform separation transfer control for separating the received composite packet into the plurality of packets and providing instructions to transfer the respective separated packets. This can make it possible to transfer the separated respective packets instead of transferring the composite packet containing the plurality of packets.

In the communication system described above, the respective separated packets may be transferred via different channels for each packet. This can prevent a collision of the transmission processes or the transfer processes of the plurality of packets.

The receiver included in the communication system described above may include the table management section that manages the transfer table in which the address information and the transfer destination information are linked. The transmission control section may be configured to provide instructions to perform the separation transfer control when the address information of at least one packet of the plurality of packets contained in the composite packet is stored in the transfer table, and to transfer the composite packet when none of the address information of the plurality of packets contained in the composite packet is stored in the transfer table. Consequently, the transfer of the composite packet is performed when the appropriate transfer destination devices are unknown, thereby allowing to execute the transmission and reception processes in a highly efficient manner.

A transmitter according to the present invention includes the transmitting section capable of transmitting the composite packet in which the plurality of packets is contained, and the receipt control section configured to provide, after transmitting the composite packet, a receipt acknowledgement time period for receiving the receipt acknowledgement signal for each of the plurality of packets.

A receiver according to the present invention includes the receiving section capable of receiving the composite packet in which the plurality of packets is contained, and the transmission control section configured to provide instructions for transmitting the receipt acknowledgement signal after the waiting time period has elapsed after the reception of the composite packet, the waiting time period being provided according to the location of the packet addressed to the own station in the plurality of packets contained in the composite packet.

A communication method according to the present invention is a communication method to be performed by a transmitter and a receiver, and the method includes transmitting a composite packet in which a plurality of packets is contained, receiving the composite packet, taking out a packet addressed to own station from the received composite packet, and providing instructions for transmitting a receipt acknowledgement signal after a waiting time period has elapsed after the reception of the composite packet, the waiting time period being provided according to a location of the packet addressed to the own station in the plurality of packets contained in the composite packet. The above-described communication system can be realized with this communication system.

According to the present invention, throughput can be improved when performing data transmission with respect to a plurality of devices.

### BRIEF DESCRIPTION OF THE DRAWINGS

FIG. 1 schematically shows a wireless mesh network;

FIG. 2 shows a block diagram of a wireless apparatus;

FIG. 3 shows a data structure of a packet;

FIG. 4 shows a transfer priority table;

FIG. 5 shows a data structure of a composite packet;

FIG. 6 is a schematic illustration diagram of a packet transmission example 1;

FIG. 7 is a schematic illustration diagram of the packet transmission example 1;

FIG. 8 is a schematic illustration diagram of the packet transmission example 1;

FIG. 9 is a schematic illustration diagram of the packet transmission example 1;

FIG. 10 is a timing chart of the packet transmission example 1;

FIG. 11 is a schematic illustration diagram of a packet transmission example 2;

FIG. 12 is a schematic illustration diagram of the packet transmission example 2;

FIG. 13 is a schematic illustration diagram of the packet transmission example 2;

FIG. 14 is a timing chart of the packet transmission example 2;

FIG. 15 is a schematic illustration diagram of a packet transmission example 3;

FIG. 16 is a schematic illustration diagram of the packet transmission example 3;

FIG. 17 is a timing chart of the packet transmission example 3;

FIG. 18 is a flowchart of processes that are executed upon receipt of the composite packet;

FIG. 19 is a flowchart of processes that are executed upon receipt of the composite packet;

FIG. 20 is a flowchart of processes that are executed upon receipt of the composite packet; and

FIG. 21 is a flowchart of processes that are executed upon receipt of the composite packet.

### DETAILED DESCRIPTION OF THE EXEMPLARY EMBODIMENTS

An embodiment of the present invention will be explained in the following order:
1. Configuration of communication system
2. Packet structure
2-1. Ordinary packet
2-2. ACK packet
2-3. Composite packet
3. Packet transmission example 1
4. Packet transmission example 2
5. Packet transmission example 3
6. Flowchart
7. Summary

### 1. Configuration of Communication System

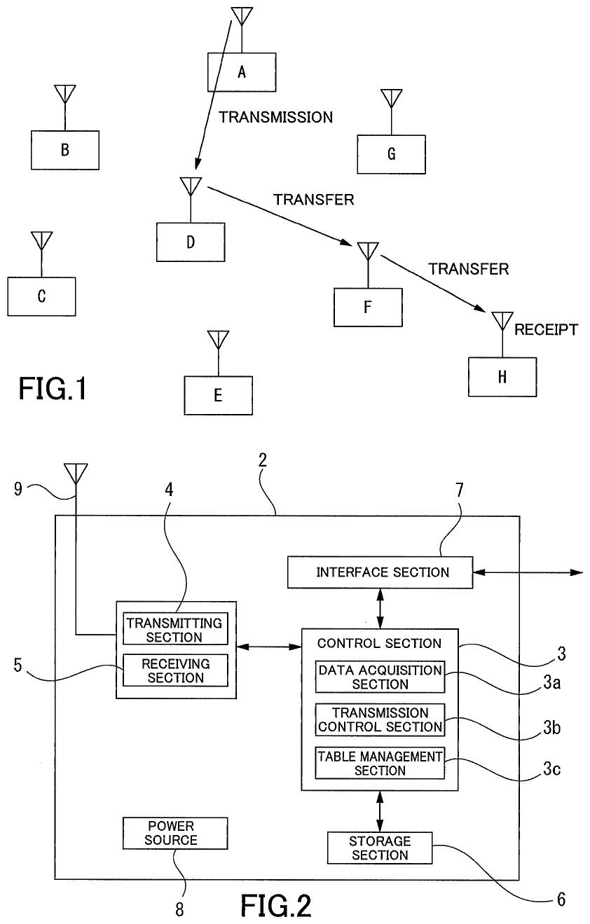

A communication system 1 according to one embodiment will be explained with reference to the attached drawings. FIG. 1 conceptually shows a wireless mesh network constituted of the communication system 1.

A wireless mesh network shown in FIG. 1 is constituted of eight wireless apparatuses, namely, wireless apparatuses A to H. Each of the wireless apparatuses A to H includes a communication range according to its communicable distance and is capable of directly communicating with another wireless apparatus within the communication range. The communication ranges of the wireless apparatuses A to H are, for example, several tens of meters radius to several hundreds of meters radius from the wireless apparatus.

To transmit information from one wireless apparatus to another wireless apparatus located outside the communication range, the information is transmitted via some wireless apparatuses. For example, in FIG. 1, to transmit information from the wireless apparatus A to the wireless apparatus H, the information is transmitted via the wireless apparatuses D, F. At this time, the wireless apparatuses D, F execute transfer processes for transferring the received information to another wireless apparatus.

Herein, the number of the wireless apparatuses that constitute the wireless mesh network is not limited to eight. In the following description, although the wireless apparatuses according to this example are fixed at respective locations, some or all of the wireless apparatuses may be movable.

A frequency range used in the wireless mesh network may be around 429 MHz, 920 MHz, 1.2 GHz, 2.4 GHz, 5 GHz, etc., for example. Respective examples described below can be implemented regardless of the frequency range used. Thus, the frequency ranges mentioned herein are examples only and other frequency ranges may be used.

FIG. 2 is a block diagram of a wireless apparatus 2 as the wireless apparatus A to H shown in FIG. 1. The wireless apparatus 2 includes a control section 3, a transmitting section 4, a receiving section 5, a storage section 6, an interface section 7, a power source 8 and an antenna section 9.

For example, the control section 3 includes a central processing unit and is configured to execute processes such as a process of generating a packet, a process of reading a header portion of a received packet and transferring it depending on the situation, and a process of generating (or updating) a transfer table.

Specifically, the control section 3 includes a data acquisition section 3a, a transmission control section 3b and a table management section 3c. The data acquisition section 3a executes a process of acquiring, from the received packet, user data stored in a message region. In this embodiment, a packet transmitted and received by the wireless apparatus 2 includes a composite packet. The composite packet herein is a packet constituted of a plurality of packets combined together. The data acquisition section 3a executes a process of taking out one packet from the composite packet and/or a process of breaking the composite packet into respective packets.

The transmission control section 3b provides instructions for transmission with respect to the transmitting section 4. For example, the instructions for transmission include designation of transmission timing and/or a frequency range (e.g., channel) to be used.

The table management section 3c is configured to manage various information such as a transfer table and a transfer priority table. In the transfer table, combinations of: a device corresponding to a source at which data transmission is originated; a transmission destination device to which the data is finally transmitted; a device from which the data is transferred to itself; and a device to which itself is to transfer the data, are stored. The control section 3 determines to which device it should transfer the data based on a device corresponding to a source at which data transmission is originated, a transmission destination device to which the data is finally transmitted, and a device from which the data is transferred to itself. The transfer priority table is a table used to determine a transfer timing when transferring the packet. The transfer priority table will be described in more detail hereinafter.

The transmitting section 4 and the receiving section 5 are constituted as IC (Integrated Circuit), for example. The transmitting section 4 and the receiving section 5 may be constituted as a single IC. In this case, the IC may be constituted of a modulator, a power amplifier, a high-frequency amplifier and a demodulator that are configured integrally. The transmitting section 4 is configured to execute a process of transmitting the packet provided from the control section 3 to another wireless apparatus 2. The receiving section 5 is configured to execute a process of receiving the packet transmitted from another wireless apparatus 2 and providing it to the control section 3.

The storage section 6 is constituted of, for example, ROM (Read Only Memory) and/or RAM (Random Access Memory) and such, in which various programs to be executed by the control section 3 and various tables (e.g., the transfer table and the transfer priority table) used by the control section 3 to determine a transmission destination (or a transfer destination) of the packet are stored. In addition, the storage section 6 also functions as a work area when the control section 3 executes various processes.

The interface section 7 is configured to accept input of information to be transmitted to another wireless apparatus 2 from an external device. The interface section 7 is also configured to output information received from another wireless apparatus 2 to a device connected to the interface section 7. The interface section 7 employs start-stop synchronous communication standard (RS-232C), for example.

The power source 8 is configured to supply power to the respective sections of the wireless apparatus 2 (e.g., the control section 3, the transmitting section 4, the receiving section 5, the storage section 6, the interface section 7, the antenna section 9, etc.). The power source 8 may supply power via a lithium-ion battery or a dry-cell battery, or via DC power supply or AC power supply, for example.

The embodiment described below refers to an example in which the wireless apparatus A is connected by wire with a device IN-1. The device IN-1 is a device that does not have wireless capabilities and may be, for example, a measuring device such as a thermometer, manometer and a flowmeter, or a control device such as the one that provides some output. As is the case with the wireless apparatus A, a wireless apparatus B is connected by wire with a device IN-2, a wireless apparatus C is connected by wire with a device IN-3, a wireless apparatus D is connected by wire with a device IN-4, and a wireless apparatus E is connected by wire with a device IN-5. Other wireless apparatuses are also connected by wire with some devices. The communication system 1 may include a wireless apparatus that is not connected with any device and that is configured to execute transferring only, and/or may include a wireless apparatus connected by wire with two or more devices.

### 2. Packet Structure

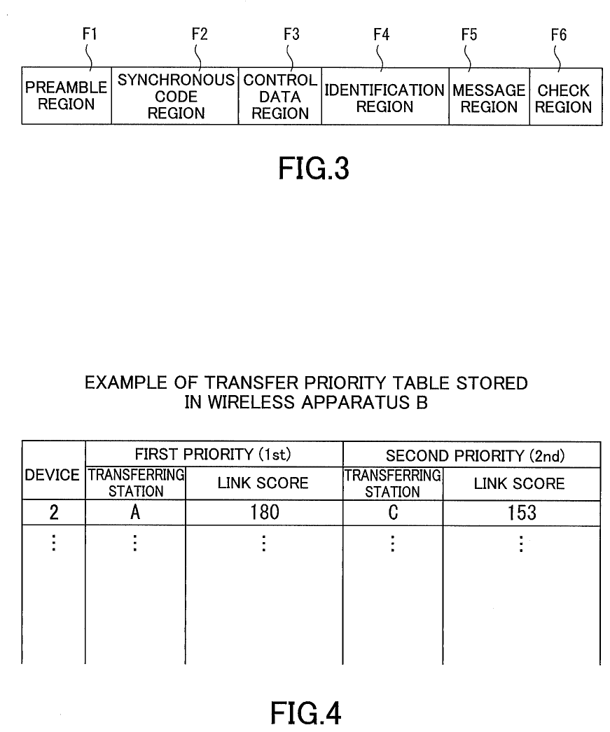

Next, a packet that flows across the wireless mesh network according to this embodiment will be explained with reference to FIG. 3. Herein, as the packet, there is a packet that includes instructions for making a device to perform some operations and/or measurement results obtained from the measurement by a device and that is transferred repeatedly between the wireless apparatuses 2 and reaches to a target device or a target wireless apparatus 2, and there is also a packet that is transmitted as a receipt acknowledgement signal to notify a transmission source (or a transfer source) that the packet is properly received. In the following, the former is referred to as “ordinary packet” and the latter is referred to as “ACK (Acknowledgement) packet”.

2-1. Ordinary Packet

FIG. 3 shows a structure of the ordinary packet including user data. The ordinary packet includes respective regions that include user data (i.e., information that a user wants to transmit), and the ordinary packet reaches to a transmission destination device (e.g., a measuring device) after being transmitted/transferred repeatedly from a destination source wireless apparatus. The ordinary packet is constituted of a preamble region F1, a synchronous code region F2, a control data region F3, an identification region F4, a message region F5 and a check region F6.

In the preamble region F1, a signal for allowing recognition of start of communication to a receiving device and for providing timing for synchronizing, is stored.

In the synchronous code region F2, data for synchronizing the wireless apparatuses is stored.

In the control data region F3, information such as information indicative of data length of a packet, a packet type and channel information indicative of a frequency used in the communication are stored. Further, information indicative of a packet location is stored in the control data region F3. A packet location will be described later in more detail in an explanation for a composite packet structure.

In the identification region F4, a transmission source station address, a transmission destination address, a transfer source station address and a transfer destination station address are stored. The transmission source station address is information for identifying the wireless apparatus 2 that corresponds to a source at which the transmission was originated. In the example shown in FIG. 1, such wireless apparatus 2 is the wireless apparatus A. For example, the transmission source station address is a wireless apparatus address of the wireless apparatus 2 that has generated a packet.

The transmission destination address is information for identifying a device to which a packet is to be finally provided. In the example shown in FIG. 1, such device is the wireless apparatus H or a device connected to the wireless apparatus H. For example, a device address of a measuring device connected by wire to the wireless apparatus 2 is stored as the transmission destination address.

The transfer source station address is information for identifying the wireless apparatus 2 that corresponds to a transfer source, and is, for example, a wireless apparatus address and such. The transfer destination station address is information for identifying the wireless apparatus 2 that corresponds to a transfer destination, and is, for example, a wireless apparatus address and such. The transfer source station address and the transfer destination station address are information that will be rewritten in an appropriate manner each time transfer is executed.

In this embodiment, the wireless apparatus 2 performs unicast communication with designating the wireless apparatus 2 as a transfer destination, and broadcast communication without designating the wireless apparatus 2 as a transfer destination. When performing the broadcast communication without defining a transfer destination, information indicating that the transfer is not targeted at a specific wireless apparatus (e.g., all bits are set to 1) is stored in the transfer destination station address region.

Further, information indicative of priority concerning the transfer process is stored in the identification region F4. The information indicative of priority is constituted of first-priority information and second-priority information, for example. The information indicative of priority is information that indicates from which wireless apparatus a packet should be received for each final transmission destination, i.e., transmission destination address.

For example, when transmitting a packet to the device IN-2 connected to the wireless apparatus B, the wireless apparatus B selects whether to receive a packet from the wireless apparatus A or receive a packet from the wireless apparatus C, based on a link score representing communication quality between the devices. This selecting process is executed based on a table indicating from which wireless apparatus 2 the wireless apparatus B should receive a packet. This table is herein referred to as “transfer priority table”. FIG. 4 is one example of the transfer priority table stored in the wireless apparatus B. As shown, the link score with respect to the wireless apparatus A is higher than the link score with respect to the wireless apparatus C, thus the transfer priority table shows that the packet to be transmitted to the device IN-2 should be received from the wireless apparatus A. The wireless apparatus B stores this table information in the identification region F4 when transmitting an ACK packet.

The wireless apparatus A that has received the ACK packet from the wireless apparatus B confirms that the wireless apparatus B has received the transferred packet and recognizes that itself (i.e., the wireless apparatus A) is given the first priority (“1st”) for the wireless apparatus B by checking the transfer priority table stored in the identification region F4. In the similar manner, the wireless apparatus C recognizes that itself (i.e., the wireless apparatus C) is given the second priority (“2nd”) for the wireless apparatus B by checking the transfer priority table.

From this point on, when the wireless apparatus A receives the packet to be transmitted to the device IN-2, the wireless apparatus A will preferentially transfer the packet to the wireless apparatus B.

Further, the wireless apparatus C that has received the packet to be transmitted to the device IN-2 will transfer the packet to the wireless apparatus B if the wireless apparatus A has failed to transfer the packet properly. In the case where the wireless apparatus C itself is given the second priority (“2nd”), the wireless apparatus C waits for a waiting time period needed by another wireless apparatus 2 that is given the first priority concerning the transfer process and then executes the transfer process as necessary.

The message region F5 is a region in which user data is stored and in which payload data is stored. The user data may be, for example, instruction data with respect to a device, measurement data to be transmitted to the wireless apparatus 2 which is the transmission source, or the like.

The check region F6 is a region in which a redundancy code for detecting an error in the respective data included in the packet is stored. For example, the redundancy code for detecting only an error in the user data is stored in the check region F6. The error checking can be executed in any manner, and correction of error may also be executed.

2-2. ACK Packet

A structure of an ACK packet not including the user data corresponds to the ordinary packet shown in FIG. 3 with the message region F5 removed. That is, the ACK packet is constituted of the preamble region F1, the synchronous code region F2, the control data region F3, the identification region F4 and the check region F6.

When the wireless apparatus 2 that is connected by wire to a final transmission destination device has received the ordinary packet that was transmitted to said final transmission destination device, the ACK packet will be transmitted to other wireless apparatuses located within the communication range, thus the ACK packet is a packet for showing the surrounding device that the packet was received safely.

2-3. Composite Packet

In this embodiment, in addition to transmitting and receiving the ordinary packet and the ACK packet, the wireless apparatus 2 transmits and receives a composite packet.

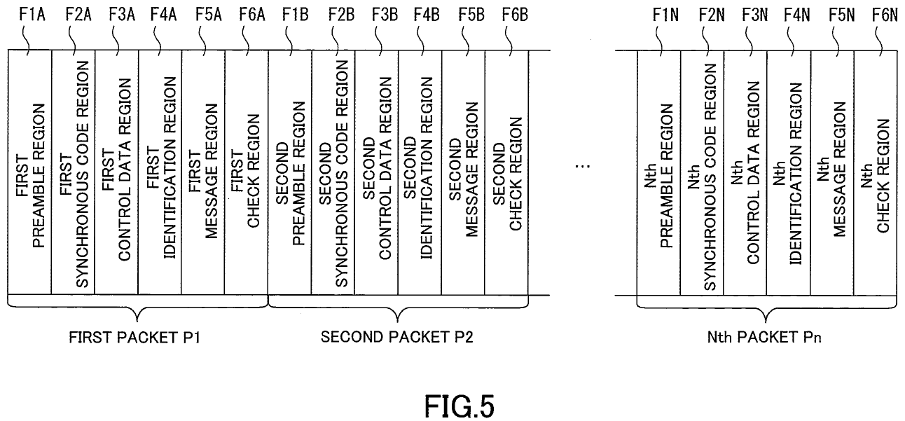

The composite packet is a packet that includes a plurality of ordinary packets. In other words, the composite packet is generated to transmit a plurality of ordinary packets in one frame at once. In the following, a detailed data structure of the composite packet will be described with reference to FIG. 5.

The composite packet shown in FIG. 5 includes n ordinary packets (i.e., number of the ordinary packets is n). Data at the beginning of the composite packet is data of a first packet P1 which is the first packet, and data of a second packet P2 which is a second packet continues after the data of the first packet. Data of a nth packet Pn which is a nth packet continues at the end of the composite packet.

As shown, the composite packet is constituted of only regions contained in the ordinary packets. That is, a dedicated region for the composite packet is not provided. The composite packet is formed by simply arranging the ordinary packets in series. Since a dedicated data region for the composite packet is not provided, the composite packet can be generated easily.

In the control data regions F3 of the respective ordinary packets contained in the composite packet, information similar to that of the ordinary packet is stored. Specifically, such information may be, for example, information indicative of data length of the ordinary packet, a packet type and channel information indicative of a frequency used in the communication. Further, as described above, information indicative of a packet location is stored in the control data region F3.

The information indicative of the data length of the ordinary packet is information that indicates the data length of each ordinary packet. For example, information of the data length of the first packet P1 is stored in the first control data region F3A of the first packet P1. In the similar manner, information of the data length of the second packet P2 is stored in the second control data region F3B of the second packet P2, and information of the data length of the nth packet Pn is stored in the nth control data region F3N of the nth packet Pn.

The information indicative of a packet location is information that indicates a place in the composite packet where each ordinary packet is located. For example, information indicating that the location of the first packet P1 is first out of n (i.e., 1/n) is stored in the first control data region F3A of the first packet P1. In the similar manner, information indicating that the location of the second packet P2 is second out of n (i.e., 2/n) is stored in the second control data region F3B of the second packet P2, and information indicating that the location of the nth packet Pn is nth out of n (i.e., n/n) is stored in the nth control data region F3N of the nth packet Pn. As described later, the information indicative of a packet location is used during determination of the transmission timing of the ACK packet.

It should be noted that the structure of the composite packet shown in FIG. 5 is an example only. For example, the preamble region F1 may be provided only in the first packet P1. That is, the preamble region F1B in the second packet P2, the preamble region F1C in the third packet P3, . . . , and the preamble region F1N in the nth packet Pn, may be omitted.

### 3. Packet Transmission Example 1

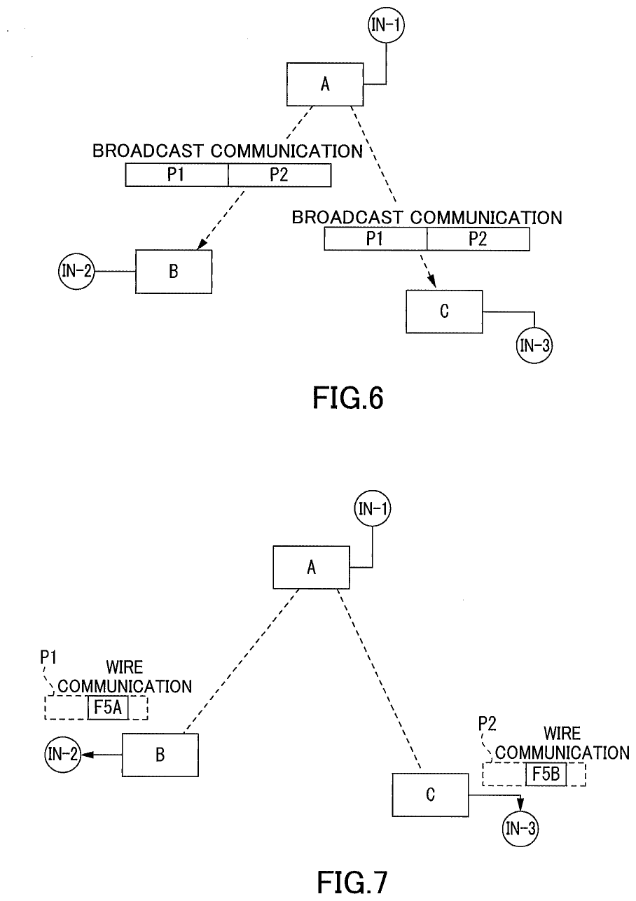

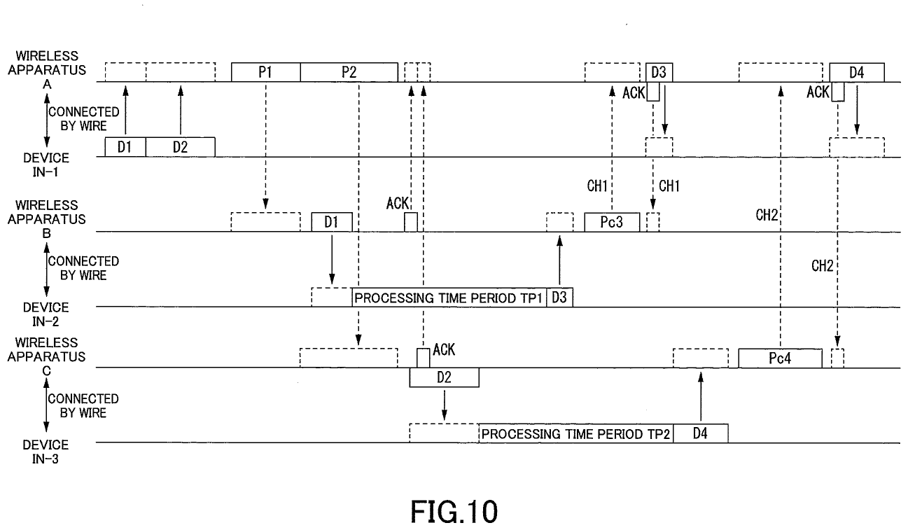

A packet transmission example 1 will be described below with reference to FIG. 6 to FIG. 9. Also, a timing chart in the packet transmission example 1 is shown in FIG. 10. In FIG. 10, an arrow with a solid line corresponds to a wire communication, and an arrow with a dotted line corresponds to a wireless communication. In addition, the wireless apparatuses A, B and C perform carrier sensing or the like when using wireless communication and execute a process of judging whether the frequency range used can be utilized in the communication or not, but this is not shown in the drawing.

In this example, transmission of the ordinary packet from the wireless apparatus A to which the device IN-1 is connected by wire to the device IN-2 and the device IN-3 is executed. It is noted that the wireless apparatus A does not know the locations of the device IN-2 and the device IN-3, and the wireless apparatuses 2 to which the respective ordinary packets should be transferred are unknown. That is, the wireless apparatus A has the transfer table in which transmission destinations of the packets for the device IN-2 and the device IN-3 are not stored.

The device IN-1 generates transmission data D1 to be transmitted to the device IN-2 and transmission data D2 to be transmitted to the device IN-3, and subsequently outputs the transmission data D1, D2 to the wireless apparatus A and requests the wireless apparatus A to execute a transmission process (refer to FIG. 10). The wireless apparatus A receives the transmission data D1 for the device IN-2 and the transmission data D2 for the device IN-3, and generates the ordinary packet for the device IN-2 and the ordinary packet for the device IN-3. Then, the wireless apparatus A generates the composite packet. Specifically, the wireless apparatus A generates the composite packet including the ordinary packet for the device IN-2 as the first packet P1 and the ordinary packet for the device IN-3 as the second packet P2.

The wireless apparatus A executes transmission of the composite packets via the broadcast communication (refer to FIG. 6 and FIG. 10). The composite packets transmitted by the wireless apparatus A are received by the wireless apparatus B and the wireless apparatus C (refer to FIG. 6 and FIG. 10).

The wireless apparatus B knows that itself is a device to which the device IN-2 is connected by wire. Further, the wireless apparatus C knows that itself is a device to which the device IN-3 is connected by wire.

The wireless apparatus B checks the transmission destination address stored in the first identification region F4A of the first packet P1 contained in the composite packet, and figures out that the first packet P1 is for the device IN-2. The wireless apparatus B takes out the first packet P1 contained in the composite packet, executes the error checking (or error correction), and then extracts information (i.e., the transmission data D1) stored in the first message region F5A and outputs is to the device IN-2 (refer to FIG. 7 and FIG. 10).

The wireless apparatus C checks the transmission destination address stored in the first identification region F4A of the first packet P1 and confirms that the first packet P1 is not for the device IN-3, and figures out a start location of the second packet P2 based on the data length of the first packet P1 stored in the first control data region F3A. Then, the wireless apparatus C checks the second identification region F4B of the second packet P2 and thereby figures out that the second packet P2 is for the device IN-3.

The wireless apparatus C takes out the second packet P2 from the composite packet, executes the error checking (or error correction), and then extracts information (i.e., the transmission data D2) stored in the second message region F5B and outputs is to the device IN-3 (refer to FIG. 7 and FIG. 10).

That is, the composite packets are converted into the ordinary packets in the wireless apparatus B and the wireless apparatus C.

The wireless apparatus B and the wireless apparatus C transmit the ACK packets, respectively, to notify the wireless apparatus A that the first packet P1 and the second packet P2 have been received properly.

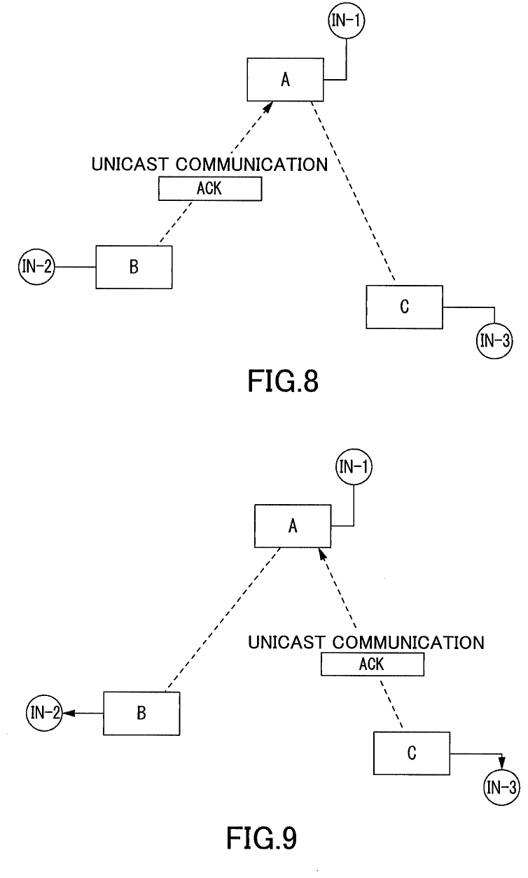

Since the wireless apparatus B transmits the ACK packet regarding the first packet P1 that is the first ordinary packet out of the plurality of ordinary packets contained in the composite packet, the wireless apparatus B transmits the ACK packet regarding the first packet P1 once the process of receiving the composite packet ends (refer to FIG. 8 and FIG. 10).

On the other hand, since the wireless apparatus C transmits the ACK packet regarding the second packet P2 that is the second ordinary packet out of the plurality of ordinary packets contained in the composite packet, the wireless apparatus C transmits the ACK packet regarding the second packet P2 after waiting the waiting time period needed for another wireless apparatus 2 to transmit the ACK packet regarding the first packet P1 (refer to FIG. 9 and FIG. 10).

As such, when transmitting the ACK packet regarding one ordinary packet contained in the composite packet after the composite packet is received, the ACK packet is transmitted after waiting the waiting time period associated with the location of this ordinary packet in the composite packet. The information of the location of the ordinary packet in the composite packet is stored in the identification region F4 as described above. Consequently, the transmission of the ACK packet by the wireless apparatus B and the transmission of the ACK packet by the wireless apparatus C do not interfere each other, thereby avoiding the need for retransmission processing.

The transmission of the ACK packets by the wireless apparatus B and the wireless apparatus C is executed via unicast communication, for example.

The subsequent processes will be explained with reference to FIG. 10. After the transmission data D1 is inputted to the device IN-2, the device IN-2 executes a process based on the transmission data D1 such as a measuring process, for example, and generates reply data D3. The device IN-2 then outputs the generated reply data D3 to the wireless apparatus B and requests for the transmission (reply).

The wireless apparatus B generates the ordinary packet Pc3 from the reply data D3 and transmits it to the wireless apparatus A.

After receiving the ordinary packet Pc3, the wireless apparatus A takes out the reply data D3 from the ordinary packet Pc3 and outputs it to the device IN-1, and transmits the ACK packet to the wireless apparatus B.

After the transmission data D2 is inputted to the device IN-3, the device IN-3 executes a process based on the transmission data D2 such as a measuring process, for example, and generates reply data D4. The device IN-3 then outputs the generated reply data D4 to the wireless apparatus C and requests for the transmission (reply).

The wireless apparatus C generates the ordinary packet Pc4 from the reply data D4 and transmits it to the wireless apparatus A.

After receiving the ordinary packet Pc4, the wireless apparatus A takes out the reply data D4 from the ordinary packet Pc4 and outputs it to the device IN-1, and transmits the ACK packet to the wireless apparatus C.

The wireless communication with respect to the transmission data D1 that is performed after the device IN-2 has received the transmission data D1, and the wireless communication with respect to the transmission data D2 that is performed after the device IN-3 has received the transmission data D2, may be performed via difference channels to prevent interference in communications. For example, as shown in FIG. 10, a channel CH1 may be used when transmitting the ordinary packet Pc3 from the wireless apparatus B to the wireless apparatus A and when transmitting the ACK packet from the wireless apparatus A to the wireless apparatus B. Further, a channel CH2 may be used when transmitting the ordinary packet Pc4 from the wireless apparatus C to the wireless apparatus A and when transmitting the ACK packet from the wireless apparatus A to the wireless apparatus C.

As such, using different channels for the transmission and reception with respect to the transmission data D1 and for the transmission and reception with respect to the transmission data D2 is advantageous in that, for example, when it is necessary to perform data transmission and reception with another wireless apparatuses (e.g., the wireless apparatus D and/or the wireless apparatus E) as a process regarding the transmission data D1, it is possible to prevent the data transmission timings from overlapping. This can avoid unnecessary retransmission process to be executed, thereby improving efficiency of the wireless communications.

FIG. 10 is an example of the case where both of the wireless apparatus B and the wireless apparatus C do not execute the transferring of the packet. In some aspects, at least one of the wireless apparatus B and the wireless apparatus C may execute the transfer process for transferring the separated packet. For example, in the case where the wireless apparatus B executes the transfer process, if the transfer process is executed immediately after the composite packet is received, then there is a risk that, at the wireless apparatus A, the reception of the ACK packet transmitted from the wireless apparatus C via the channel CH2 and the reception of the first packet P1 (i.e., reception as a proxy ACK packet) transmitted from the wireless apparatus B via the channel CH1 may interfere each other.

In that case, the wireless apparatus B may execute the transfer process of the first packet P1 with delay to avoid overlapping with the transmission of the ACK packet by the wireless apparatus C. Alternatively, the transmission of the ACK packet by the wireless apparatus C may be delayed, such that the wireless apparatus A can receive the ACK packet from the wireless apparatus C after receiving the proxy ACK packet from the wireless apparatus B.

### 4. Packet Transmission Example 2

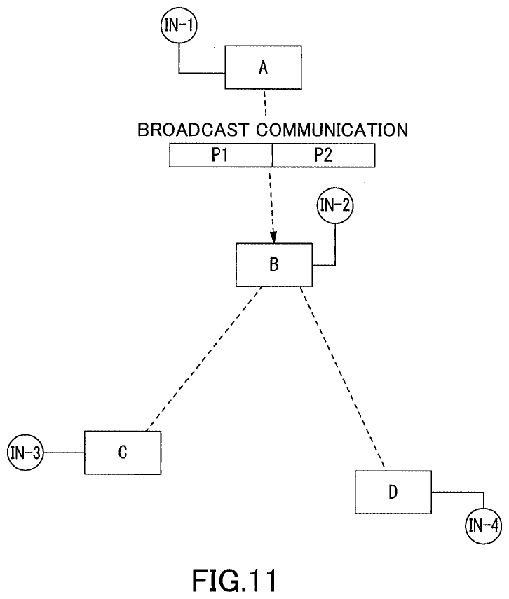

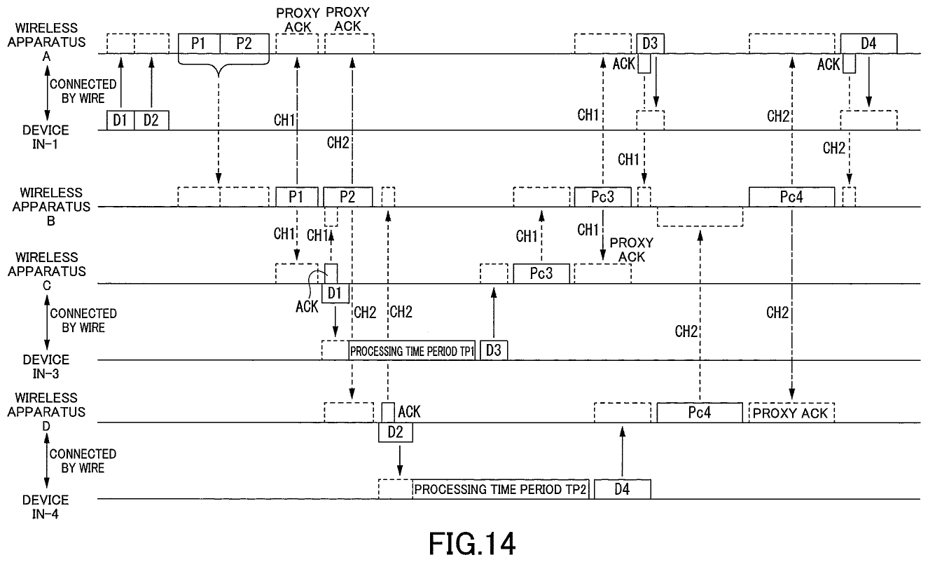

A packet transmission example 2 will be described below with reference to FIG. 11 to FIG. 13. Also, a timing chart in the packet transmission example 2 is shown in FIG. 14. In FIG. 14, an arrow with a solid line corresponds to a wire communication, and an arrow with a dotted line and an arrow with a dashed-dotted line correspond to a wireless communication.

In this example, transmission of the ordinary packet from the wireless apparatus A to the device IN-3 and the device IN-4 is executed. It is noted that the wireless apparatus A does not know the locations of the device IN-3 and the device IN-4, and the wireless apparatuses 2 to which the respective ordinary packets should be transferred are unknown. That is, the wireless apparatus A has the transfer table in which transmission destinations (transfer destinations) of the packets for the device IN-3 and the device IN-4 are not stored.

In the similar manner as the previously described example, the wireless apparatus A generates the ordinary packet for the device IN-3 and the ordinary packet for the device IN-4 based on the transmission data D1 for the device IN-3 and the transmission data D2 for the device IN-4 that are inputted from the device IN-1, and generates the composite packet (refer to FIG. 14). Specifically, the wireless apparatus A generates the composite packet including the ordinary packet for the device IN-3 as the first packet P1 and the ordinary packet for the device IN-4 as the second packet P2.

The wireless apparatus A executes transmission of the composite packet via the broadcast communication (refer to FIG. 11 and FIG. 14). The composite packet transmitted by the wireless apparatus A is received by the wireless apparatus B.

The wireless apparatus B knows that it is the wireless apparatus C that is the wireless apparatus 2 as the most appropriate transfer destination for transferring the information to the device IN-3. Further, the wireless apparatus B knows that it is the wireless apparatus D that is the wireless apparatus 2 as the most appropriate transfer destination for transferring the information to the device IN-4. That is, the transfer destination station address for the packet to be transmitted to the device IN-3 and the transfer destination station address for the packet to be transmitted to the device IN-4, are stored in the transfer table included in the wireless apparatus B.

The wireless apparatus B checks the transmission destination address stored in the first identification region F4A of the first packet P1 contained in the composite packet and figures out that the first packet P1 is for the device IN-3.

Further, the wireless apparatus B checks the transmission destination address stored in the second identification region F4B of the second packet P2 contained in the composite packet and figures out that the second packet P2 is for the device IN-4.

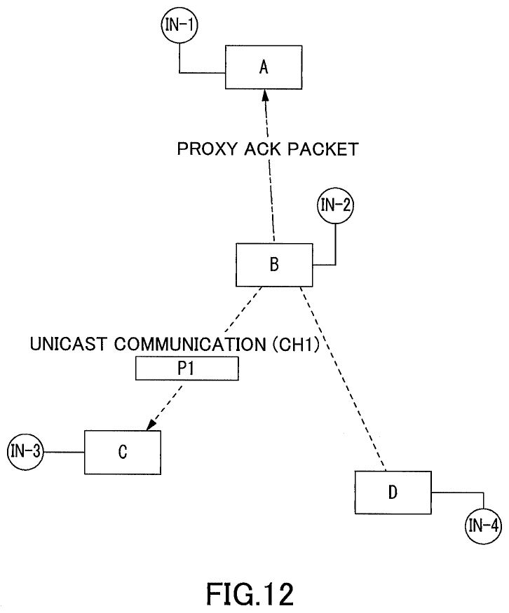

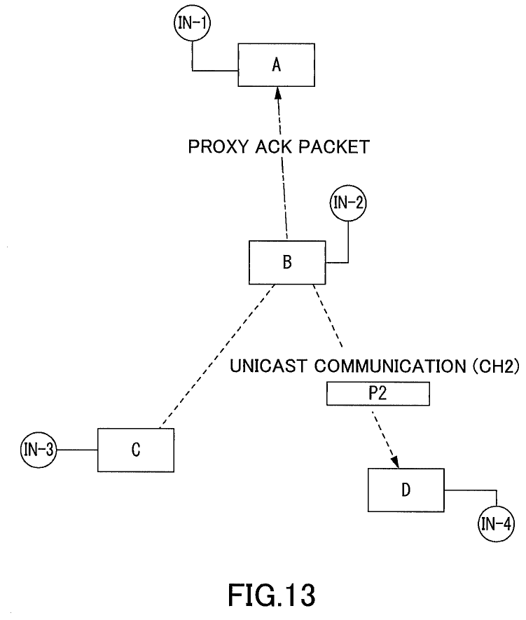

The wireless apparatus B separates the first packet P1 and the second packet P2 contained in the composite packet and transfers these first and the second packets as separate ordinary packets. At this time, the first packet P1 is transferred via the channel CH1 (refer to FIG. 12), and the second packet P2 is transferred via the channel CH2 (refer to FIG. 13 and FIG. 14). To do that, the wireless apparatus B determines to transmit the first packet P1 via the channel CH1 and subsequently stores information (e.g., a channel number) for identifying the channel CH1 in the first control data region F3A of the first packet P1. In addition, the wireless apparatus B determines to transmit the second packet P2 via the channel CH2 and subsequently stores information for identifying the channel CH2 in the second control data region F3B of the second packet P2.

As such, the first packet P1 and the second packet P2 will be transferred via different channels, respectively, thereby avoiding a collision of packets and allowing efficient data transmission.

Herein, since the most appropriate transfer destinations for the respective ordinary packets are provided, these ordinary packets are transferred via unicast communications.

It is desirable that the determination of the channel to be used in the communication is performed in the wireless apparatus B in which the composite packet is separated. For example, it may be considered that the wireless apparatus A that has generated the composite packet can determine, in advance, the channel to be used for the transmission of the first packet P1 and the channel to be used for the transmission of the second packet P2. In this case, however, since the wireless apparatus B has a better grasp of the communication environment around the wireless apparatus B than the wireless apparatus A, if the wireless apparatus A determines the channels in advance, then the wireless apparatus B cannot select the channel with a high communication quality, and this could possibly lead to frequent packet loss. In this example, the wireless apparatus B that performs the separating of the composite packet also performs the determination of the channels to be used, thus the transfer processing can be carried out with high communication quality, thereby reducing the possibility of causing retransfer of the packet and improving the throughput.

In the case where the wireless apparatus A knows the communication environment (e.g., the link scores) between all the wireless apparatuses, the channels to be used may be set at the wireless apparatus A. However, as shown with respect to the packet transmission example 1, in the case where the process of transmitting the plurality of packets via the different channels is not executed, the process of determining the channels to be used is needless. Thus, the process of determining the channels should not be applied when it is unnecessary, so that the processing load can be reduced.

The first packet P1 and the second packet P2 transferred from the wireless apparatus B are also sent to the wireless apparatus A as shown in the dashed-dotted line in FIG. 12, FIG. 13 and FIG. 14. By receiving the respective ordinary packets transferred by the wireless apparatus B, the wireless apparatus A recognizes that the composite packet has been safely received by the wireless apparatus B. That is, for the wireless apparatus A, the first packet P1 and the second packet P2 transferred from the wireless apparatus B are the packets that can be treated as proxy for the ACK packets. Such packets are hereinafter referred to as “proxy ACK packets”. The proxy ACK packet may be the ordinary packet obtained by separating the composite packet as this example, or it may be the composite packet.

The wireless apparatus C that has received the first packet P1 via the channel CH1, executes the error checking for the first packet P1, and then extracts the information (i.e., the transmission data D1) stored in the first message region F5A and outputs it to the device IN-3. Further, the wireless apparatus C transmits to the wireless apparatus B the ACK packet regarding the first packet P1. The frequency range used at this time is the channel CH1.

With respect to the wireless apparatus D which has received the second packet P2 via the channel CH2, the wireless apparatus D executes the error checking for the second packet P2, and then extracts the information (i.e., the transmission data D2) stored in the second message region F5B and outputs it to the device IN-4. Further, the wireless apparatus D transmits the ACK packet regarding the second packet P2 to the wireless apparatus B via the channel CH2.

The subsequent processes will be explained with reference to FIG. 14. After the transmission data D1 is inputted to the device IN-3, the device IN-3 executes a process based on the transmission data D1 such as a measuring process, for example, and generates reply data D3. The device IN-3 then outputs the generated reply data D3 to the wireless apparatus C and requests for the transmission (reply).

The wireless apparatus C generates the ordinary packet Pc3 from the reply data D3 and transmits it to the wireless apparatus B.

After receiving the ordinary packet Pc3, the wireless apparatus B transfers this ordinary packet Pc3 to the wireless apparatus A. The ordinary packet Pc3 transferred in this transfer process is sent to the wireless apparatus A and is also sent to the wireless apparatus C as the proxy ACK packet (refer to the dashed-dotted line in FIG. 14).

After receiving the ordinary packet Pc3, the wireless apparatus A takes out the reply data D3 from the ordinary packet Pc3 and outputs it to the device IN-1, and transmits the ACK packet to the wireless apparatus B.

In addition, after the transmission data D2 is inputted to the device IN-4, the device IN-4 executes a process based on the transmission data D2 such as a measuring process, for example, and generates reply data D4. The device IN-4 then outputs the generated reply data D4 to the wireless apparatus D and requests for the transmission.

The wireless apparatus D generates the ordinary packet Pc4 from the reply data D4 and transmits it to the wireless apparatus B.

After receiving the ordinary packet Pc4, the wireless apparatus B transfers this ordinary packet Pc4 to the wireless apparatus A. The ordinary packet Pc4 transferred in this transfer process is sent to the wireless apparatus A and is also sent to the wireless apparatus D as the proxy ACK packet (refer to the dashed-dotted line in FIG. 14).

After receiving the ordinary packet Pc4, the wireless apparatus A takes out the reply data D4 from the ordinary packet Pc4 and outputs it to the device IN-1, and transmits the ACK packet to the wireless apparatus B.

### 5. Packet Transmission Example 3

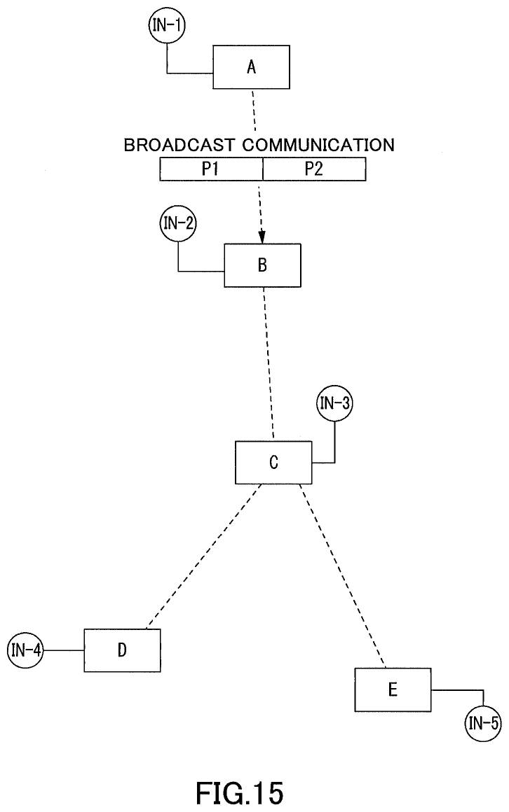

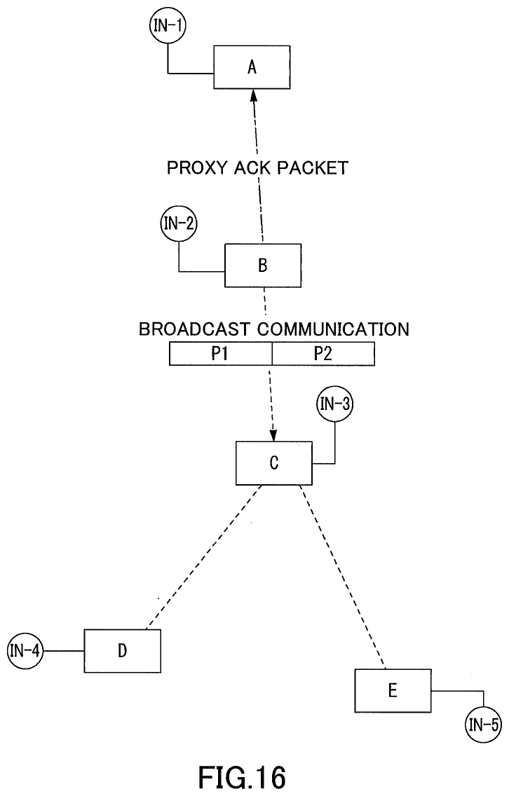

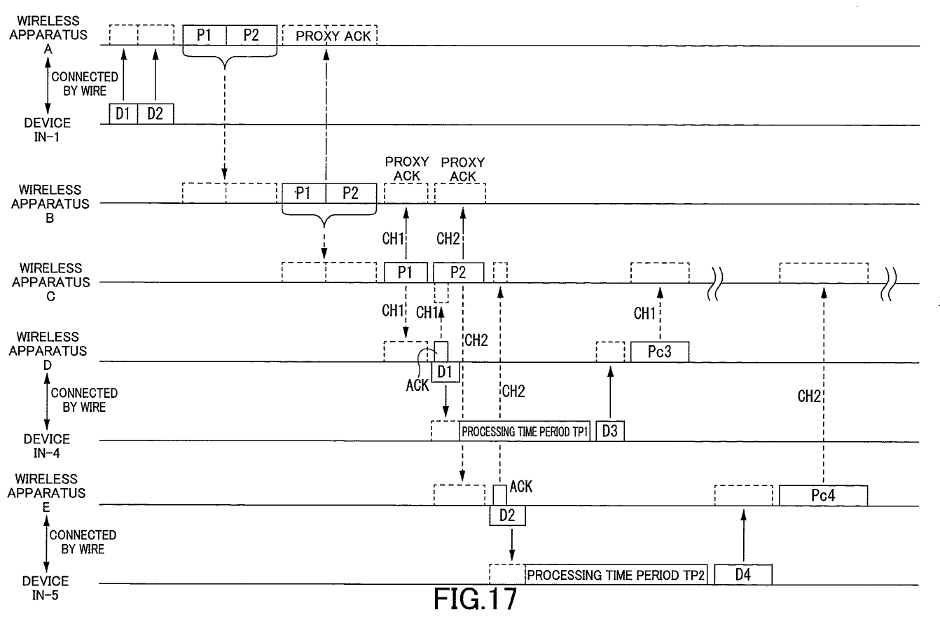

A packet transmission example 3 will be described below with reference to FIG. 15 and FIG. 16. Also, a timing chart in the packet transmission example 3 is shown in FIG. 17. In FIG. 17, an arrow with a solid line corresponds to a wire communication, and an arrow with a dotted line and an arrow with a dashed-dotted line correspond to a wireless communication.

In this example, transmission of the ordinary packet from the wireless apparatus A to the device IN-4 and the device IN-5 is executed. It is noted that the wireless apparatus A does not know the locations of the device IN-4 and the device IN-5, and the wireless apparatuses 2 to which the respective ordinary packets should be transferred are unknown. That is, the wireless apparatus A has the transfer table in which transmission destinations (transfer destinations) of the packets for the device IN-4 and the device IN-5 are not stored.

In the similar manner as the previously described example, the wireless apparatus A generates the ordinary packet for the device IN-4 and the ordinary packet for the device IN-5 based on the transmission data D1 for the device IN-4 and the transmission data D2 for the device IN-5 that are inputted from the device IN-1, and generates the composite packet (refer to FIG. 17). Specifically, the wireless apparatus A generates the composite packet including the ordinary packet for the device IN-4 as the first packet P1 and the ordinary packet for the device IN-5 as the second packet P2.

The wireless apparatus A executes transmission of the composite packet via the broadcast communication (refer to FIG. 15 and FIG. 17). The composite packet transmitted by the wireless apparatus A is received by the wireless apparatus B.

Similar to the wireless apparatus A, the wireless apparatus B does not know the locations of the device IN-4 and the device IN-5, and also the wireless apparatuses 2 to which the respective packets should be transferred are unknown. Thus, the wireless apparatus B executes the transferring of the received composite packet also by the broadcast communication (refer to FIG. 16 and FIG. 17).

The composite packet transferred by the wireless apparatus B is sent to the wireless apparatus C and is also sent to the wireless apparatus A as the proxy ACK packet (refer to the dashed-dotted line in FIG. 16 and FIG. 17).

Behavior of the wireless apparatus C which has received the composite packet is similar to the wireless apparatus B of the packet transmission example 2, hence it will be explained briefly with reference to FIG. 17. That is, the wireless apparatus C that has received the composite packet separates the composite packet into the first packet P1 and the second packet P2. The wireless apparatus C knows the locations of the device IN-4 and the device IN-5 and has the transfer table in which the transfer destinations of the packets for the device IN-4 and the device IN-5 are stored. Based on the information stored in the transfer table, the wireless apparatus C transfers the first packet P1 to the wireless apparatus D via the unicast communication using the channel CH1 and transfers the second packet P2 to the wireless apparatus E via the unicast communication using the channel CH2.

Further, behaviors of the wireless apparatus D and the wireless apparatus E which has received the respective ordinary packets from the wireless apparatus C via the unicast communication are similar to the behaviors of the wireless apparatus C and the wireless apparatus D of the packet transmission example 2. That is, the wireless apparatus D and the wireless apparatus E extract from the received packet the data stored in the message region F5 and output it to the devices to which they are connected via wire, and transmits the ACK packets.

The device IN-4 and the device IN-5 execute the processes based on the received transmission data D1, D2 and generate the reply data D3, D4. The reply data D3, D4 are transferred from the wireless apparatus D and the wireless apparatus E through the wireless apparatuses C, B and to the wireless apparatus A.

As the case of the wireless apparatus B of this example, if the transfer destinations of the respective ordinary packets contained in the received composite packets are unknown, then the transfer process is executed with the composite packet as it is. Consequently, as shown in FIG. 17, the reception of the respective ACK packets corresponding to the respective ordinary packets (i.e., the proxy ACK packets) take place after the transfer process of the composite packet, allowing for efficient transmission and reception. In particular, in the case where the transmission waiting time period is provided after the transmission process or the transfer process, the ACK packets or the proxy ACK packets can be received collectively during the transmission waiting time period, thereby allowing for efficient use of the transmission waiting time period. As a result, throughput can be improved.

### 6. Flowchart

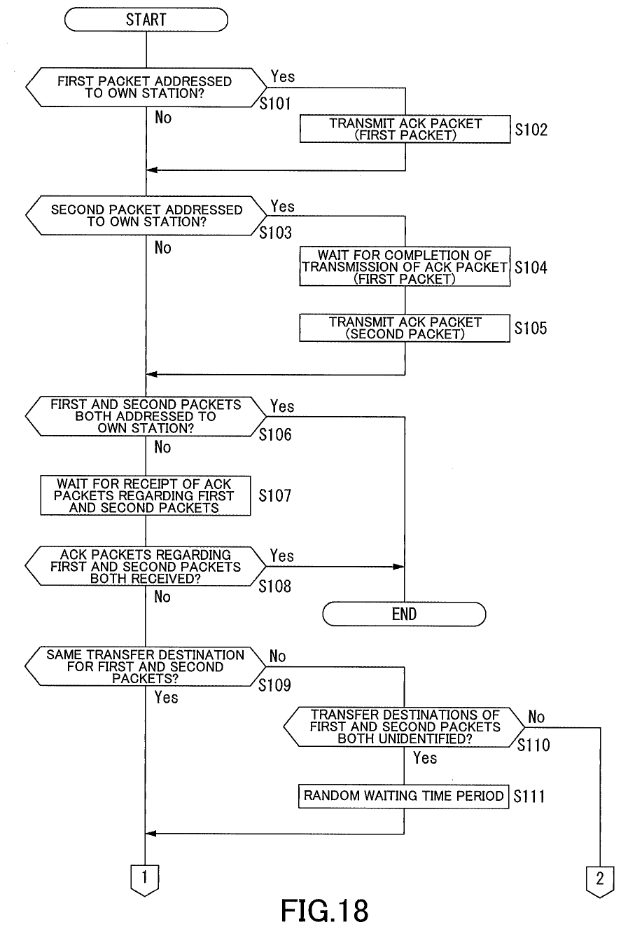

Next, the processes to be executed by the wireless apparatus 2 described in the respective examples will be described below with reference to the flowcharts shown in FIG. 18 to FIG. 21.

These flowcharts show the processes to be executed by the wireless apparatus 2 that has received the composite packet. In the following description, the wireless apparatus 2 that receives the composite packet and executes the respective processes is referred to as “wireless apparatus 2A” and is described as “own station” or “oneself”, as needed. Further, the wireless apparatus 2 that receives the transferred packet from the wireless apparatus 2A, or the wireless apparatus 2 that transmits the packet to the wireless apparatus 2A, is simply referred to as “wireless apparatus 2” and described as “another station”, as needed. In addition, the composite packet described in the following example is constituted of two ordinary packets, namely, the first packet P1 and the second packet P2.

In step S101 shown in FIG. 18, the wireless apparatus 2A that has received the composite packet checks the transmission destination address stored in the first identification region F4A of the first packet P1, and determines whether the first packet P1 is addresses to own station (i.e., the wireless apparatus 2A oneself) or not, that is, whether the first packet P1 is addressed to the device that is connected via wire to the own station or not.

If the first packet P1 is for the own station, then the wireless apparatus 2A transmits the ACK packet in step S102.

After it is confirmed that the first packet P1 is not for the own station, or after the ACK packet regarding the first packet P1 has been transmitted, the wireless apparatus 2A checks the transmission destination address stored in the second identification region F4B of the second packet P2, and determines whether the second packet P2 is for the own station (i.e., the wireless apparatus 2A oneself) or not, in step S103.

If the second packet P2 is for the own station, then the wireless apparatus 2A waits for the waiting time period needed for the transmission of the ACK packet regarding the first packet P1 in step S104, and then transmits the ACK packet regarding the second packet P2 in step S105.

After it is confirmed that the second packet P2 is not for the own station, or after the ACK packet regarding the second packet P2 has been transmitted, the wireless apparatus 2A determines whether both of the first packet P1 and the second packet P2 are for the own station or not, in step S106.

If both of the first packet P1 and the second packet P2 are for the own station, then the reception of the two ordinary packets contained in the composite packet and the transmission of the ACK packets (i.e., steps S102 and S105) are now finished, thus the wireless apparatus 2A finishes with the series of processes based on the reception of the composite packet.

On the other hand, if at least one of the first packet P1 and the second packet P2 is for another station, then it is necessary to transfer this packet for another station. In this instance, the wireless apparatus 2A executes the process as indicated in step S107 and the subsequent steps.

In step S107, the wireless apparatus 2A waits for the reception of the ACK packets regarding the first packet P1 and the second packet P2. For example, in the case where the composite packet is received by another station and the another station has taken out the first packet P1 from the composite packet and has transmitted the ACK packet, this ACK packet is sent to the wireless apparatus 2A depending on the locational relationship between the own station (i.e., the wireless apparatus 2A) and the another station. When the ACK packet transmitted by the another station was received by the wireless apparatus 2A, the wireless apparatus 2A can figure out that the corresponding ordinary packet was safely sent to the target wireless apparatus 2, hence the wireless apparatus 2A does not need to execute the transferring of the corresponding ordinary packet. Thus, the process of step S107 is a waiting process to wait for the reception of the ACK packet transmitted by the another station to determine whether to execute the transferring of the ordinary packet or not.

In step S108, if the wireless apparatus 2A determines that it has received the ACK packets (or may be the proxy ACK packet) regarding the first packet P1 and the second packet P2 transmitted by another station(s), then the process for transferring the first packet P1 and the second packet P2 will be no longer necessary, thus the wireless apparatus 2A finishes the series of processes based on the reception of the composite packet.

On the other hand, if the wireless apparatus 2A has not received the ACK packet regarding at least one of the first packet P1 and the second packet P2, then the wireless apparatus 2A needs to execute the process for transferring the packet. In this instance, the wireless apparatus 2A determines, in step S109, whether the transfer destinations of the first packet P1 and the second packet P2 are the same or not.

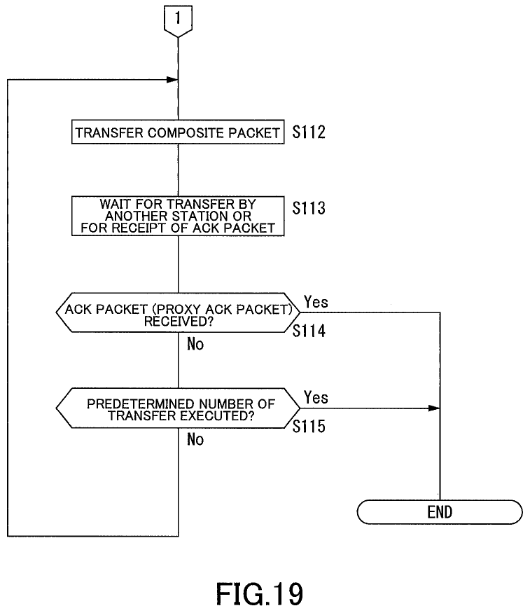

If the transfer destinations are the same, then the wireless apparatus 2A proceeds to the process indicated in step S112 shown in FIG. 19. On the other hand, if the transfer destinations are different from each other, then the wireless apparatus 2A checks, in step S110, whether the transfer destinations to which the first packet P1 and the second packet P2 should be transferred can both be identified in the transfer table stored in the storage section 6 or not. This process includes finding out, from the transfer table, a record having the transmission source station address, the transmission destination address and the transfer source station address that are concordant with those stored in the first identification region F4A of the first packet P1, and thereby identifies the transfer destination device. The similar process is executed with respect to the second packet P2.

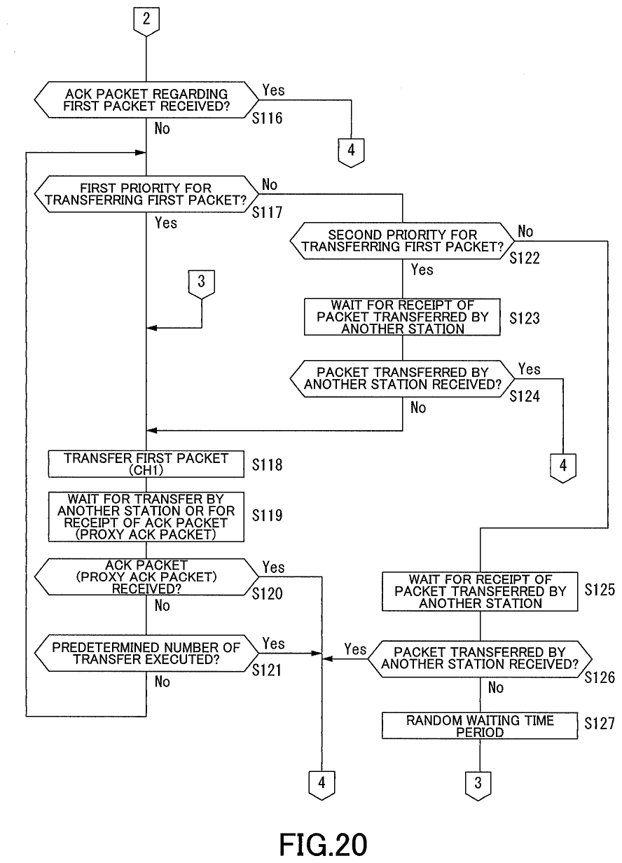

If both transfer destination devices could not be identified, that is, the wireless apparatus 2 to which the first packet P1 should be transferred and the wireless apparatus 2 to which the second packet P2 should be transferred are not identified, then the wireless apparatus 2A waits for a random wait time period in step S111, and proceeds to the process indicated in step S112 shown in FIG. 19. On the other hand, if the transfer destination devices were identified, that is, the wireless apparatuses 2 to which the packets should be transferred were identified, then the wireless apparatus 2A proceeds to the process indicated in step S116 shown in FIG. 20.

In step S112 shown in FIG. 19, the wireless apparatus 2A execute the transferring of the composite packet. If the transfer destinations of the first packet P1 and the second packet P2 are the same wireless apparatus 2 (Yes in step S109 shown in FIG. 18), then there is no need to separate the composite packet, thus the process for transferring the composite packet is executed in step S112 shown in FIG. 19.

If both of the transfer destinations of the first packet P1 and the second packet P2 could not be identified (Yes in step S110 shown in FIG. 18), then in this instance also, there is no need to separate the composite packet because the transfer destinations are unknown, thus the process for transferring the composite packet is executed in step S112 shown in FIG. 19.

After the process for transferring the composite packet, the wireless apparatus 2A waits for the waiting time period to wait for the transfer process(es) by another wireless apparatus(es) 2 to be executed, in step S113. During this waiting time period, the wireless apparatus 2A also waits for receiving the ACK packet(s). It is noted that, as mentioned above, in the case where the composite packet was separated at the wireless apparatus 2 as the transfer destination, the ACK packet regarding the first packet P1 and the ACK packet regarding the second packet P2 may both be transmitted from the transfer destination (refer to FIG. 10). In this case, the ACK packet regarding the second packet P2 is received after receiving the ACK packet regarding the first packet P1. The waiting time period in step S113 is set to be equal to or longer than the time period required at least for receiving these two ACK packets.

After waiting for the waiting time period, the wireless apparatus 2A determines, in step S114, whether it has received the ACK packet(es) or not, or whether it has received the proxy ACK packet(es) or not. If the wireless apparatus 2A has received the ACK packet(es) or the proxy ACK packet(es), then it is confirmed that the composite packet was sent to any of the wireless apparatuses 2 by the transfer process executed by the wireless apparatus 2A, thus the wireless apparatus 2A finishes with the series of processes based on the reception of the composite packet.

On the other hand, if the wireless apparatus 2A could not receive any of the ACK packet and the proxy ACK packet, then the wireless apparatus 2A determines, in step S115, whether it has executed predetermined number of transfer process regarding this composite packet or not. If the predetermined number of transfer process had been executed, then no further transfer process is executed and the wireless apparatus 2A finishes with the series of processes based on the reception of the composite packet. If the predetermined number of transfer process has not been executed, the wireless apparatus 2A returns to step S112 and the process for transferring the composite packet is executed again. The processes of step S112 and the step S113 are executed repeatedly until the reception of the ACK packet(es) or the proxy ACK packet(es) is confirmed or until the predetermined number of transfer process is executed.

A process of step S116 shown in FIG. 20 is a process that is executed in the case where the transfer destinations of the first packet P1 and the second packet P2 are different from each other (No in step S109 shown in FIG. 18) and at least one of the transfer destinations of the first packet P1 and the second packet P2 is known (No in step S110).

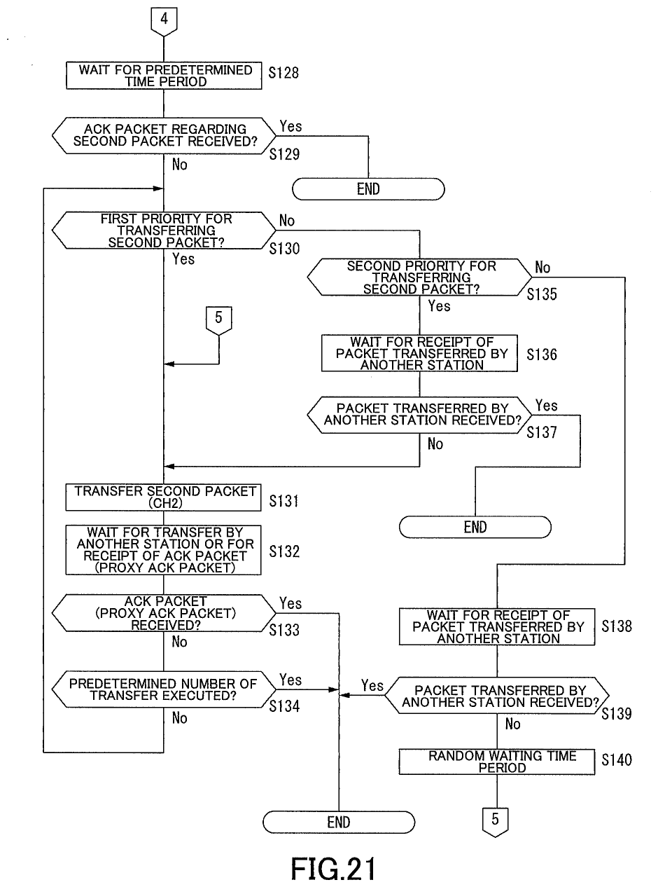

In step S116, the wireless apparatus 2A determines whether it has received the ACK packet regarding the first packet P1 that was transmitted from the wireless apparatus 2 as the transfer destination (i.e., a planned transfer destination) or not. If the wireless apparatus 2A has received the ACK packet, then it is confirmed that the first packet P1 was safely transferred by another wireless apparatus 2 to the wireless apparatus 2 as the transfer destination, thus the wireless apparatus 2A finishes with the process regarding the first packet P1 and proceeds to step S128 shown in FIG. 21 to execute a process regarding the second packet P2.

On the other hand, if the wireless apparatus 2A has not received the ACK packet regarding the first packet P1 from the wireless apparatus 2 as the transfer destination (i.e., the planned transfer destination), then it is necessary to transfer the first packet P1 to the wireless apparatus 2 as the transfer destination, thus the wireless apparatus 2A proceeds to a process indicated in step S117.

In step S117, the wireless apparatus 2A checks whether it is given the first priority concerning the process for transferring the first packet P1 to the wireless apparatus 2 as the transfer destination (i.e., the planned transfer destination) or not. This process makes reference to the transfer priority table.

If the wireless apparatus 2A is given the first priority concerning the process for transferring the first packet P1, then the wireless apparatus 2A executes the process for transferring the first packet P1 in step S118. At this time, since the wireless apparatus 2 as the transfer destination is known, the unicast communication designating the wireless apparatus 2 as the transfer destination is used. In addition, the channel CH1 is used in this communication used in this transfer process. As will be described later, the channel CH1 is different from the channel used in the process for transferring the second packet P2 that is executed in the subsequent step.

Next, in step S119, the wireless apparatus 2A waits for the waiting time period to wait for the transfer executed by the wireless apparatus 2 as the transfer destination or for the transmission of the ACK packet by the wireless apparatus 2 as the transfer destination. During this waiting time period, the wireless apparatus 2A also waits for receiving the ACK packet or the proxy ACK packet.

In step S120, the wireless apparatus 2A checks whether it has received the ACK packet or the proxy ACK packet from the wireless apparatus 2 as the transfer destination or not. If the wireless apparatus 2A has received the ACK packet or the proxy ACK packet, then it is confirmed that the process for transferring the first packet P1 to the wireless apparatus 2 was completed properly, thus the wireless apparatus 2A proceeds to step S128 shown in FIG. 21 to execute the process regarding the second packet P2.

On the other hand, if the reception of the ACK packet or the proxy ACK packet could not be confirmed, then the wireless apparatus 2A determines, in step S121, whether predetermined number of transfer process was executed or not. If the predetermined number of transfer process was executed, then the wireless apparatus 2A abandons the process for transferring the first packet P1 and proceeds to step S128 shown in FIG. 21 to execute the process regarding the second packet P2. If the predetermined number of transfer process was not executed, then the wireless apparatus 2A returns to step S117 and executes again the process regarding the first packet P1.

In step S117, if it was determined that the wireless apparatus 2A is not given the first priority concerning the process for transferring the first packet P1, then the wireless apparatus 2A proceeds to step S122 and determines whether it is given the second priority concerning the process for transferring the first packet P1 or not.

If it was determined that the wireless apparatus 2A is given the second priority concerning the process for transferring the first packet P1, then, in step S123, the wireless apparatus 2A waits for another station (i.e., the wireless apparatus 2 which is given the first priority concerning the transfer process) to execute the transfer process. During this waiting time period, the wireless apparatus 2A waits for receiving the first packet P1 transferred by the another station.

Next, the wireless apparatus 2A determines, in step S124, whether it has received the first packet P1 transferred by said wireless apparatus 2 which is given the first priority concerning the transfer process or not. If it is determined that it has received the first packet P1, then it is confirmed that the transfer process by another wireless apparatus 2 was executed, thus the wireless apparatus 2A proceeds to step S128 shown in FIG. 21 to execute the process regarding the second packet P2.

On the other hand, if it was determined that it could not receive the first packet P1, then the wireless apparatus 2A executes the respective processes indicated in step S118 through step S121, thereby executing the process of transferring the first packet P1. This transfer process is executed for several times, as needed.

If it was determined in step S117 that the wireless apparatus 2A is not given the first priority concerning the process of transferring the first packet P1, and further if it was determined in step S122 that the wireless apparatus 2A is even not given the second priority concerning the process of transferring the first packet P1, then the wireless apparatus 2A proceeds to step S125 and waits for another stations (i.e., the wireless apparatus 2 which is given the first priority concerning the transfer process and the wireless apparatus 2 which is given the second priority concerning transfer process) to execute the transfer process. During this waiting time period, the wireless apparatus 2A waits for receiving the first packet P1 transferred by the another station.

In step S126, the wireless apparatus 2A determines whether it has received the first packet P1 transferred by the wireless apparatus 2 which is given the first priority/the second priority or not. If it was determined that it has received the first packet P1, then it is confirmed that the transfer process by another wireless apparatus 2 was executed, thus the wireless apparatus 2A proceeds to step S128 shown in FIG. 21 to execute the process regarding the second packet P2.

On the other hand, if it was determined that the wireless apparatus 2A could not receive the first packet P1, then the wireless apparatus 2A waits for a random waiting time period in step S127 and then executes the respective processes indicated in step S118 through step S121, thereby executing the process of transferring the first packet P1. The random waiting time period is provided to avoid overlapping in timing of execution of transfer processes that are executed by the plurality of wireless apparatuses 2. In addition, the transfer process in step S118 is executed for several times, as needed.

After executing the respective processes with respect to the first packet P1 (i.e., the respective steps in step S116 through step S127), the wireless apparatus 2A executes the respective processes with respect to the second packet P2 (i.e., the respective steps in step S128 through step S140 shown in FIG. 21).

Firstly, the wireless apparatus 2A waits for a predetermined time period in step S128. This predetermined time period is provided such that the process of transferring the second packet P2 is not executed immediately after the process of transferring the first packet P1, and is provided to avoid an exclusive use of a frequency range by one wireless apparatus 2 continuously performing the transfer processes.

After waiting for the predetermined time period, the wireless apparatus 2A determines, in step S129, whether it has received the ACK packet regarding the second packet P2 that was transmitted from the wireless apparatus 2 as the transfer destination (i.e., a planned transfer destination) or not. This process is similar to the process in step S116 shown in FIG. 20, with the target to be processed being changed from the first packet P1 to the second packet P2. In addition, the subsequent respective processes from step S130 to step S140 are also similar to the respective processes from step S117 to step S127 shown in FIG. 20, with the target to be processed being changed from the first packet P1 to the second packet P2. This, the explanations of the processes are omitted.

It is noted that, unlike the process of transferring the first packet P1, the process of transferring the second packet P2 (step S131) uses the channel CH2. Consequently, the communication regarding the first packet P1 and the communication regarding the second packet P2 will be performed using difference channels, thereby preventing interference in the communications and allowing to execute transfer processes and such in an efficient manner.

The flowcharts in FIG. 18 through FIG. 21 shows an example in which the composite packet contains the first packet P1 and the second packet P2; however, the composite packet may further contain a third packet P3 and a fourth packet P4. In such instance, the series of processes shown in FIG. 20 with the target to be processed being changed to the third packet P3, and the series of processes shown in FIG. 20 with the target to be processed being changed to the fourth packet P4 may be sequentially executed.

### 7. Summary

As explained with reference to the respective examples described above, the communication system 1 includes the transmitter (i.e., the wireless apparatus 2) and the receiver (i.e., the wireless apparatus 2). The transmitter includes the transmitting section 4 which is capable of transmitting the composite packet containing the plurality of packets (e.g., the first packet P1 and the second packet P2). The receiver includes the receiving section 5 capable of receiving the composite packet, the data acquisition section 3a configured to take out a packet addressed to own station from the received composite packet, and the transmission control section 3b configured to provide instructions for transmitting the receipt acknowledgement signal (i.e., the ACK packet) after the waiting time period has elapsed after the reception of the composite packet, the waiting time period being provided according to the data location of the packet addressed to the own station in the composite packet, as described with reference to FIG. 10. Consequently, time to receive the receipt acknowledgement signal (i.e., the ACK packet) after the transmission of the composite packet is provided collectively at the transmitter (i.e., the wireless apparatus 2). Consequently, amount of time required for transmission and reception can be reduced compared to the case where the transmission of the packet and the reception of the receipt acknowledgement signal are performed alternately, thereby improving the throughput. Specifically, when the transmission waiting time period having a certain time period is provided after the transmission of the packet, the transmission waiting time period can be allotted for a reception time period for receiving the plurality of receipt acknowledgement signals, thereby allowing the transmission and reception processes to be executed in a highly efficient manner. As described above, the data structure of the composite packet is formed by simply connecting the plurality of ordinary packets, and it not provided with a header region or the like for the composite packet. This can prevent an increase in the data length of the composite packet, resulting in an improvement in throughput. Further, since the header region or the like for the composite packet is not provided, possible destruction of data of a part of the ordinary packet contained in the composite will not have an effect on other ordinary packets. As the composite packet contains the plurality of ordinary packets, the composite packet has the data length longer than that of the ordinary packet and thus an error occurrence rate may increase; however, the error occurrence rate for each ordinary packet is unchanged. Thus, even if an error occurs in a part of the composite packet, this does not require a retransfer process or a retransmission process for all the ordinary packets contained in the composite packet. Consequently, throughput can be improved.

As described with respect to FIG. 5, the composite packet may be provided with the region (i.e., the control data region F3) for each of the plurality of packets in which information indicative of the data location (i.e., the location of the packet) in the composite packet is stored. Thus, the information indicative of the data location of the packet addressed to the own station can be obtained from the composite packet at the receiver (i.e., the wireless apparatus 2). Consequently, the timing for transmission of the receipt acknowledgement signal (i.e., the ACK packet) can be determined easily.

As described with respect to step S112 shown in FIG. 19, the transmission control section 3b may provide instructions for transferring the composite packet instead of transmitting the receipt acknowledgement signal (ACK packet) when all of the plurality of packets (e.g., the first packet P1 and the second packet P2) contained in the received composite packet are not addressed to the own station. When all of the plurality of packets contained in the received composite packet are not addressed to the own station, the transfer of the composite packet may be carried out. Further, the composite packet transferred by the receiver (e.g., the wireless apparatus B in FIG. 16) is also sent to the transmitter (e.g., the wireless apparatus A in FIG. 16) that has transmitted the composite packet to this receiver. Thus, the transmitter can know that the composite packet that it has transmitted was sent to the receiver. Consequently, the transmitter regards the reception of the composite packet transferred by the receiver as an alternative to the reception of the receipt acknowledgement signal, thereby omitting the process of receiving the receipt acknowledgement signal. Also, the receiver performs the transfer of the composite packet instead of transmitting the receipt acknowledgement signal, thereby omitting the process of transmitting the receipt acknowledgement signal. Consequently, the processes of transmitting and receiving the receipt acknowledgement signal can be omitted, thereby reducing the processing load.

As described with respect to the packet transmission example 2 using FIG. 12 and FIG. 13, the transmission control section 3b may be configured to perform separation transfer control (i.e., the processes of step S118 in FIG. 20 and step S131 in FIG. 21) for separating the received composite packet into the plurality of packets (e.g., the first packet P1 and the second packet P2) and providing instructions to transfer the respective separated packets. This can make it possible to transfer the separated respective packets instead of transferring the composite packet containing the plurality of packets. For example, in the case where the transfer destination devices to which the plurality of packets contained in the composite packet are known in advance, the separated packets can be transmitted to the respective devices via the unicast communications. Consequently, number of communications can be reduced as compared to the case of broadcast communication, thereby preventing reduction in communication quality due to congestion of channels.

As described above with reference to FIG. 14 and the flowcharts (e.g., FIG. 20 and FIG. 21), the respective separated packets (e.g., the first packet P1 and the second packet P2) may be transferred via different channels (e.g., the channel CH1 and the channel CH2) for each packet. This can prevent a collision of the transmission processes or the transfer processes of the plurality of packets. Consequently, the need for useless processes such as retransmission process can be omitted, thereby preventing reduction in communication quality.

As described with reference to the block diagrams of FIG. 2 and such, the receiver (i.e., the wireless apparatus 2) includes the table management section 3c that manages the transfer table in which the address information and the transfer destination information are linked. Also, the transmission control section 3b may be configured to provide instructions to perform the separation transfer control when the address information of at least one packet of the plurality of packets contained in the composite packet is stored in the transfer table (e.g., the case of the wireless apparatus B in the packet transmission example 2, and the wireless apparatus C in the packet transmission example 3), and to transfer the composite packet when none of the address information of the plurality of packets contained in the composite packet is stored in the transfer table (e.g., the case of the wireless apparatus B in the packet transmission example 3). Consequently, the transfer of the composite packet is performed when the appropriate transfer destination devices are unknown, thereby allowing to execute the transmission and reception processes in a highly efficient manner. On the other hand, when the appropriate transfer destination devices are known, then the separated respective packets are transferred using the unicast communications, and this can limit the device that performs the transfer process and can prevent generation of useless communications.

The transmitter included in the above-described communication system 1 includes the transmitting section 4 capable of transmitting the composite packet in which the plurality of packets (e.g., the first packet P1 and the second packet P2) is contained, and the receipt control section (i.e., the control section 3) configured to provide, after transmitting the composite packet, a receipt acknowledgement time period for receiving the receipt acknowledgement signal (i.e., the ACK packet) for each of the plurality of packets. Consequently, time to collectively receive the receipt acknowledgement signals each for each of the plurality of packets is provided, thereby allowing to perform efficient transmission and reception.

Further, the receiver included in the above-described communication system 1 includes the receiving section 5 capable of receiving the composite packet in which the plurality of packets (e.g., the first packet P1 and the second packet P2) is contained, and the transmission control section 3b configured to provide instructions for transmitting the receipt acknowledgement signal (i.e., the ACK packet) after the waiting time period has elapsed after the reception of the composite packet, the waiting time period being provided according to the location of the packet addressed to the own station in the plurality of packets contained in the composite packet. Consequently, time to transmit the receipt acknowledgement signals each for each of the plurality of packets is provided collectively after the transmission of the composite packet, thereby allowing to perform efficient communication.

### LIST OF REFERENCE SIGNS

1 communication system
A, B, C, D, E, F, G, H wireless apparatus
2, 2A wireless apparatus
3a data acquisition section
3b transmission control section
3c table management section
4 transmitting section
5 receiving section
F3, F3A, F3B, F3N control data region
P1 first packet
P2 second packet
CH1, CH2 channel

What is claimed is:

1. A communication system comprising:
a transmitter; and
a receiver,
wherein the transmitter includes a transmitting section which is capable of transmitting a composite packet containing a plurality of packets, and
wherein the receiver includes
a receiving section capable of receiving the composite packet,
a data acquisition section configured to take out a packet addressed to own station from the received composite packet, and
a transmission control section configured to provide instructions for transmitting a receipt acknowledgement signal after a waiting time period has elapsed after the reception of the composite packet, the waiting time period being provided according to a data location of the packet addressed to the own station in the composite packet.

2. The communication system according to claim 1, wherein the composite packet is provided with a region for each of the plurality of packets in which information indicative of a data location in the composite packet is stored.

3. The communication system according to claim 1, wherein the transmission control section is configured to provide instructions for transferring the composite packet instead of transmitting the receipt acknowledgement signal when all of the plurality of packets contained in the received composite packet are not addressed to the own station.

4. The communication system according to claim 1, wherein the transmission control section is configured to perform separation transfer control for separating the received composite packet into the plurality of packets and for providing instructions to transfer the respective separated packets.

5. The communication system according to claim 4, wherein the respective separated packets are transferred via different channels for each packet.

6. The communication system according to claim 4, wherein the receiver includes a table management section that manages a transfer table in which address information and transfer destination information are linked, and
wherein the transmission control section is configured to provide instructions to
perform the separation transfer control when the address information of at least one packet of the plurality of packets contained in the composite packet is stored in the transfer table, and
transfer the composite packet when none of the address information of the plurality of packets contained in the composite packet is stored in the transfer table.

7. A transmitter comprising:
a transmitting section capable of transmitting a composite packet in which a plurality of packets is contained; and
a receipt control section configured to provide, after transmitting the composite packet, a receipt acknowledgement time period for receiving a receipt acknowledgement signal for each of the plurality of packets.

8. A receiver comprising:
a receiving section capable of receiving a composite packet in which a plurality of packets is contained, and
a transmission control section configured to provide instructions for transmitting a receipt acknowledgement signal after a waiting time period has elapsed after the reception of the composite packet, the waiting time period being provided according to a location of the packet addressed to own station in the plurality of packets contained in the composite packet.

9. A communication method to be performed by a transmitter and a receiver, comprising:
transmitting a composite packet in which a plurality of packets is contained;
receiving the composite packet;
taking out a packet addressed to own station from the received composite packet; and
providing instructions for transmitting a receipt acknowledgement signal after a waiting time period has elapsed after the reception of the composite packet, the waiting time period being provided according to a location of the packet addressed to the own station in the plurality of packets contained in the composite packet.
